(19) United States
(12) Patent Application Publication
(10) Pub. No.: US 2012/0225382 A1
(43) Pub. Date: Sep. 6, 2012

(54) METHOD FOR MANUFACTURING TONER

(75) Inventors: Il Sun Hwang, Daejeon (KR); Dae Il Hwang, Daejeon (KR); Sung Yul Kim, Cheongju-si (KR); Bo Young Kim, Seoul (KR); Dong Won Kim, Incheon (KR); Sung Soon Kim, Gwangmyeong-si (KR)

(73) Assignee: SAMSUNG FINE CHEMICALS CO., LTD., Ulsan (KR)

(21) Appl. No.: 13/509,855

(22) PCT Filed: Dec. 16, 2010
(86) PCT No.: PCT/KR2010/009035

§ 371 Date: May 15, 2012

(30) Foreign Application Priority Data
Dec. 16, 2009 (KR) 10-2009-0125689

(51) Int. Cl. G03G 9/087

(52) U.S. Cl. 430/137.14

(57) ABSTRACT

A method of preparing toner. Due to the use of an inorganic salt of a monovalent metal as a coagulant when toner particles are aggregated, formed toner particles have a narrow particle size distribution, low-temperature fixability, and high image quality.

### TECHNICAL FIELD

The present invention relates to a method of preparing toner, and in particular, to a method of preparing toner with a narrow particle size distribution, low-temperature fixability, and high image quality.

### BACKGROUND ART

Typically, toner is prepared by adding a colorant, a releasing agent, a charge controller, or the like to a thermoplastic resin that functions as a binder resin. Also, to provide fluidity to toner or to improve charge control or cleaning properties of toner, inorganic metal fine powder, such as silica or titanium oxide, may be added as an external additive to toner. As a method of preparing such toners, a physical method, such as milling or the like, a chemical method, such as suspension polymerization, emulsion aggregation, or the like, may be used.

From among various chemical methods, a polymerization method uses radical polymerization, and thus, only a vinyl-based resin may be used as a binder resin. In this case, however, it is difficult for polymerization to be completely terminated and thus a non-reacted monomer, a surfactant, or the like may remain in toner particles, and thus, charge characteristics of the toner particles may be degraded.

A polyester resin has better pigment dispersibility, better transparency characteristics, a lower fixing temperature, and a narrower range of glass transition temperature than a vinyl-based resin, such as a styrene-acryl-based copolymer resin. Due to these advantages, the polyester resin is suitable for use as a binder resin for toner for a high-speed printer or a color printer.

According to an example of a method of preparing toner using a polyester resin as a binder resin, polyaluminum chloride (PAC) as an agglomerating agent is used together with a mixed solution including a polyester resin dispersion, a colorant dispersion, and a wax dispersion to aggregate toner particles, followed by freezing/fusing. When polyaluminum chloride is used as a coagulant, it is difficult to deactivate polyaluminum chloride through a pH change of a reaction solution during freezing, and also, removal of a coagulant during washing and drying may also be difficult. Thus, these difficulties may adversely affect charging of toner.

Also, in preparing a polyester resin dispersion, ammonia water may be used as a dispersion stabilizer. In this case, at a temperature at which the polyester resin dispersion is prepared, ammonia may evaporate to produce unpleasant odor.

Japanese Patent Application Publication No. 11-311877 discloses that when toner is prepared by emulsion aggregation, a salt of 2 or more-valent metal ions is used as a coagulant. In this case, however, if an amount of an inorganic salt remaining in a toner particle is greater than 1 wt %, a melting viscosity when toner is fixed is substantially increased and thus fixing characteristics of toner may be degraded, and also, during washing, an inorganic salt may not be removed well. As a result, secondary aggregation may occur during washing.

### DETAILED DESCRIPTION OF THE INVENTION

### Technical Problem

The present invention provides a method of preparing toner with narrow particle size distribution, low-temperature fixability, and high image quality by using a polyester resin as a binder resin.

### Technical Solution

According to an aspect of the present invention, there is provided a method of preparing toner, wherein the method includes mixing a polyester resin dispersion, a colorant dispersion, and a wax dispersion to prepare a mixed dispersion; aggregating toner particles by adding a coagulant to the mixed dispersion; and fusing the aggregated toner particles, wherein an inorganic base of a monovalent metal is used as a dispersion stabilizer added to the polyester resin dispersion, and an inorganic salt of a monovalent metal is used as a coagulant for the aggregation.

According to an embodiment of the present invention, the inorganic base used as the dispersion stabilizer may be NaOH, KOH, or LiOH.

According to an embodiment of the present invention, the inorganic salt used as the coagulant may be NaCl or KCl.

According to an embodiment of the present invention, wherein the polyester resin may have a weight average molecular weight of 6,000 to 100,000 and a glass transition temperature of 40 to 80° C.

### Advantageous Effects

A preparation method according to the present invention may provide toner particles with narrow particle size distribution, low-temperature fixability, and high image quality

### Mode of the Invention

Hereinafter, exemplary embodiments of the present invention are described in detail below.

A method of preparing toner according to an embodiment of the present invention includes: mixing a polyester resin dispersion, a colorant dispersion, and a wax dispersion to prepare a mixed dispersion; adding an agglomerating agent to the mixed dispersion to aggregate toner particles; and fusing the aggregated toner particles, wherein an inorganic base of a monovalent metal is used as a dispersion stabilizer added to the polyester resin dispersion, and an inorganic salt of a monovalent metal is used as a coagulant for the aggregation.

The toner preparation method may further include washing and drying the coalesced toner particles.

The toner preparation method may be described in detail below with four processes: (A) a dispersion preparation process, (B) an aggregation process, (C) freezing and fusing processes, and (D) washing and drying processes.

### (1) Dispersion Preparation Process

A dispersion preparation process largely consists of three dispersion preparation processes: a polyester resin dispersion preparation process, a colorant dispersion preparation process, and a wax dispersion preparation process.

To prepare a polyester resin dispersion, a polar solvent including a surfactant and a dispersion stabilizer is added to an organic solvent that is not miscible with the polar solvent to prepare a solvent emulsion, followed by adding a polyester resin in a solid state thereto. According to the present embodiment, the polyester resin is dispersed in the polar solvent including a dispersion stabilizer, thereby enabling the preparation of a stable dispersion. In this case, a terminal of the polyester resin is ionized by the dispersion stabilizer and thus the polyester resin is stably dispersed.

The polar solvent may be water, methanol, ethanol, butanol, acetonitrile, acetone, ethyl acetate, or the like. For example, the polar solvent may be water.

A weight average molecular weight of the polyester resin may be in a range of 6,000 to 100,000, and an acid value of the polyester resin may be in a range of 8 to 20.

As an inorganic base of a monovalent metal used as the dispersion stabilizer, NaOH, LiOH, KOH, or the like may be used.

The polyester resin may be prepared by polycondensation of an acidic component and an alcoholic component, and a typical example of the acidic component is a polyvalent carboxylic acid and a typical example of the alcoholic component is a polyhydric alcohol.

Examples of the polyhydric alcohol are polyoxyethylene-(2,0)-2,2-bis(4-hydroxyphenyl)propane, polyoxypropylene-(2,0)-2,2-bis(4-hydroxyphenyl)propane, polyoxypropylene-(2,2)-polyoxyethylene-(2,0)-2,2-bis(4-hydroxyphenyl)propane, polyoxyethylene-(2,3)-2,2-bis(4-hydroxyphenyl)propane, polyoxypropylene-(6)-2,2-bis(4-hydroxyphenyl)propane, polyoxypropylene-(2,3)-2,2-bis(4-hydroxyphenyl)propane, polyoxypropylene-(2,4)-2,2-bis(4-hydroxyphenyl)propane, polyoxypropylene-(3,3)-2,2-bis(4-hydroxyphenyl)propane, polyoxyethylene-(6)-2,2-bis(4-hydroxyphenyl)propane, ethylene glycol, 1,3-propylene glycol, 1,2-propylene glycol, 1,4-butylene glycol, 1,3-butylene glycol, glycerol, and polyoxypropylene. Examples of the polyvalent carboxylic acid are an aromatic polybasic acid, an alkyl ester thereof, and a combination thereof, which are typically used in preparing a polyester resin. Examples of the aromatic polybasic acid are a terephthalic acid, an isophthalic acid, a trimellitic acid, a pyromellitic acid, a 1,2,4-cyclohexanetricarboxylic acid, a 2,5,7-naphthalenetricarboxylic acid, a 1,2,4-naphthalenetricarboxylic acid, a 1,2,5-hexanetricarboxylic acid, a 1,2,7,8-octanetetracarboxylic acid, an alkyl ester of these carboxylic acid, and a combination thereof, wherein the alkyl may be methyl, ethyl, propyl, butyl, or the like. The aromatic polybasic acid and the alkyl ester may be used alone or in combination.

Also, a glass transition temperature of the polyester resin may be in a range of 40 to 80° C., and for example, 50 to 75° C. If the glass transition temperature is lower than 40° C., toner prepared using a polyester resin particle may have poor preservation stability. Also, if the glass transition temperature is higher than 80° C., an offset may easily occur and in particular, during color printing, the offset-related problems may be more serious.

As the organic solvent used in preparing the polyester resin dispersion, at least one selected from the group consisting of methyl acetate, ethyl acetate, isopropyl acetate, methyl ethyl ketone, dimethyl ether, diethyl ether, 1,1-dichloroethane, 1,2-dichloroethane, dichloromethane, and chloroform may be used. However, other materials may also be used as the organic solvent.

An amount of the surfactant used in preparing the polyester resin dispersion may be in a range of 1 to 4 parts by weight based on 100 parts by weight of the polyester resin, and an amount of the organic solvent used in preparing the polyester resin dispersion may be in a range of 15 to 200 parts by weight, and an amount of the dispersion stabilizer used in preparing the polyester resin dispersion may be in a range of 2 to 3 equivalent amounts with respect to an acid value of the polyester resin.

The colorant dispersion may be prepared by dispersing a colorant in water by using a dispersant, such as a surfactant, or by using an organic solvent. When a colorant is dispersed in water, an anionic surfactant and a non-ionic surfactant may be used as a dispersant. For example, an anionic surfactant may be used as a dispersant. Due to the use of a dispersant, pigment may be easily dispersed in water and a dispersion particle size of the pigment in toner may be reduced, thereby enabling preparation of toner with excellent characteristics. An unnecessary dispersant may be removed by a subsequent washing process.

As the colorant, black pigment, cyan pigment, magenta pigment, yellow pigment, or a mixture thereof may be appropriately selected for use. Black pigment, cyan pigment, magenta pigment, and yellow pigment are commercially available pigments.

The colorant may be used in such an amount that toner is colorized and a visible image is formed by development. For example, based on 100 parts by weight of the polyester resin, an amount of the colorant may be in a range of 3 to 15 parts by weight. If the amount of the colorant is less than 3 parts by weight, coloring effect may be insufficient, and if the amount of the colorant is greater than 15 parts by weight, electric resistance of toner is reduced, and thus, a sufficient friction charging amount may not be obtained and pollution may occur.

A wax dispersion may be prepared by dispersing natural or synthetic wax in water or an organic solvent.

Wax may be any one of various known waxes. For example, natural wax, such as carnauba wax or rice wax, synthetic wax, such as polypropylene wax, polyethylene wax, or the like, a petroleum wax, such as montan wax or the like, an alcohol-based wax, an ester-based wax, or the like may be used. These waxes may be used alone or in combination.

If wax is dispersed in water, a surfactant or a dispersion stabilizer may be used, and a dispersing device, such as a high-pressure or high-speed homogenizer, may be used to prepare a dispersion. If wax is dispersed in an organic solvent, the same method used in preparing the polyester resin dispersion may be used. That is, an organic solvent is added to water to which a surfactant and a dispersion stabilizer have been added to prepare a solvent emulsion, and then wax is added thereto in a solid state to prepare a dispersion. An amount of wax may be in a range of 0.5 to 20 parts by weight, for example, 1 to 10 parts by weight, based on 100 parts by weight of the polyester resin.

### (B) Aggregation Process

The dispersions prepared by the dispersion preparation process above are mixed and then a coagulant and an acid are added thereto while stirring to aggregate toner particles. The aggregation process may be performed at room temperature. According to some embodiments of the present invention, the aggregation process may be performed while heating up to about a glass transition temperature Tg of the polyester resin. The stirring of the respective dispersions may be performed by using a stirrer and a mechanical shear force to prepare agglomerated particles with uniform size and shape.

As the inorganic salt of a monovalent metal used as an agglomerating agent, NaCl or KCl may be used.

An amount of the agglomerating agent may be in a range of 0.3 to 5 wt %, for example, 0.5 to 3 wt %, based on 100 parts by weight of a total solid content of a reaction solution in the aggregation process. If the amount of the agglomerating agent is less than 0.3 wt %, aggregation may not occur, and if the amount of the agglomerating agent is greater than 5 wt %, the formed agglomerated particles may be too big.

During the aggregation process, a pH of the reaction dispersion may be controlled by adding an acid thereto, and may be, for example, in a range of 4.5 to 6.5.

The aggregation process may be performed by stirring the reaction dispersion at a temperature of 40 to 60° C. at a rate of 1.0 to 7.0 m/sec.

According to the above embodiments of the present invention, the inorganic salt of a monovalent metal is used as a coagulant. Accordingly, a monovalent metal ion derived from the inorganic base of a monovalent metal used as a dispersion stabilizer when the polyester resin dispersion is prepared may function as an assistant for the coagulant. Thus, even with a small amount of coagulant, excellent aggregation effects may be obtained.

### (C) Freezing And Fusing Processes

To freeze the aggregated toner particles, the temperature of the reaction dispersion is maintained and the pH of the reaction dispersion is increased to 10.

In this regard, the pH may be increased by adding an inorganic base, such as NaOH, KOH, or LiOH.

Then, a mixed dispersion including toner particles is heated to uniformize the particle size and shape of aggregated toner particles. The heating may be performed to a temperature equal to or higher than a glass transition temperature of the polyester resin so as to control a particle size to be in a range of 1 to 20 μm, and by doing this, toner particles with almost uniform particle size and shape may be obtained.

Due to the heating at a temperature equal to or higher than the glass transition temperature of the polyester resin, surface properties of the particles may be improved. Prior to the heating to the temperature equal to or higher than the glass transition temperature of the polyester resin, a polyester resin dispersion or polystyrene butylacrylate latex may be used to cover the toner particles formed by the aggregation process so that leaking of pigment or wax included within the toner particles is prevented and toner is hardened. In this case, as the additionally used polyester resin dispersion or polystyrene butylacrylate latex, a resin dispersion that has physical properties (glass transition temperature or molecular weight) equal to or higher than those of the polyester resin dispersion used in the previous process may be used. When a polyester resin dispersion having higher physical properties is used, glass transition temperature may be in a range of 60 to 85° C. and a molecular weight may be in a range of 10,000 to 300,000. When toner particles formed by the aggregation process are covered with the additionally used resin dispersion, the particle size may be increased. To prevent the increase in the particle size, a surfactant may be used, or a pH may be controlled, or the temperature may be increased to a temperature equal to or higher than the glass transition temperature of the polyester resin to complete a fusing process.

### (D) Washing And Drying Processes

Following the fusing process, toner particles are washed with water and dried. During these processes, a mixed dispersion including toner is cooled to room temperature, followed by filtering, and a filtrate is removed therefrom and toner is washed with water. Washing may be performed with pure water with conductivity of 10 μS/cm or less, and the washing may be continuously performed until conductivity of the filtrate obtained by washing toner reaches 50 μS/cm or less. The washing of toner with pure water may be performed in a batch or continuous type. The washing of toner with pure water may be performed to remove unnecessary components other than toner, including impurities that may affect a chargeability of toner and an unnecessary coagulant that does not participate in the aggregation.

When an inorganic salt of a monovalent metal is used as a coagulant, the inorganic salt may be deactivated due to a pH change during the washing process and thus re-aggregation of toner particles may not occur, and because the inorganic salt of a monovalent metal has a substantially high solubility with respect to water compared to a multivalent metal, the inorganic salt may be easily removed by washing and thus the amount of the inorganic salt remaining inside toner may be substantially reduced, and thus, a melting viscosity of toner particles is not increased and the toner particles may have good fixing characteristics.

Following the washing, the toner is dried by using a fluidized bed dryer, a flash jet dryer, or the like.

Also, an external additive may be further added to the dried toner.

Hereinafter, embodiments of the present invention are described in detail with Examples, but the present invention is not limited to the Examples.

### Preparation Example 1

### Synthesis of Polyester Resin (1)

A 3 L reactor equipped with a stirrer, a nitrogen gas inlet, a thermometer, and a cooler was placed in an oil bath that constitutes a heat medium. 45 g of terephthalic acid, 39 g of isophthalic acid, 75 g of 1,2-propyleneglycol, and 3 g of trimellitic acid were added to the reactor, and dibutyltin oxide as a catalyst was added thereto in an amount of 500 ppm based on the total weight of a monomer. While the reactor was stirred at a rate of 150 rpm, the temperature was increased to 150° C. The reaction was performed for 6 hours and the temperature was increased up to 220° C., and a pressure of the reactor was reduced to 0.1 torr and under this pressure condition, the reaction was performed for 15 hours to obtain a polyester resin (1).

### Preparation Example 2

### Synthesis of Polyester Resin (2)

137 g of dimethyl terephthalate, 55 g of dimethyl isophthalate, 68 g of ethylene glycol, 175 g of an ethylene oxide adduct of bisphenol A, and 0.1 g of tetrabutoxy titanate as a catalyst were loaded into an autoclave including a thermometer and a stirrer and then heating was performed thereon at a temperature of 150 to 220° C. for 180 minutes to perform an ester exchange reaction. Then, the temperature was increased up to 240° C. and the pressure of the reaction system was slowly reduced so that after 30 minutes, the pressure of the reaction system was 10 mmHg, and in this state, the reaction was continuously performed for 70 minutes. Substitution with nitrogen gas was performed thereon, the pressure was controlled to an atmospheric pressure, the temperature was decreased to 200° C., 2.0 g of trimellitic acid was added thereto, and the reaction was performed for 70 minutes, thereby completing the preparation of the polyester resin (2).

### Preparation Example 3

### Synthesis of Polyester Resin (3)

215 g of terephthalic acid, 485 g of isophthalic acid, 468 g of 2,2-dimethyl-1,3-propane diol, 156 g of 1,5-pentan diol, and 0.41 g of tetrabutyl titanate as a catalyst were loaded into a reactor including a stirrer, a condenser, and a thermometer, and then an esterification was performed in a temperature range from 160° C. to 230° C. for 4 hours. The pressure was slowly reduced for 20 minutes down to 5 mmHg, and at a vacuum of 0.3 mmHg or less, a polycondensation reaction was performed at a temperature of 260° C. for 40 minutes. Under a nitrogen stream, the temperature was decreased to 220° C., and 23 g of trimellitic acid was added thereto and the reaction was performed for 30 minutes, thereby completing the preparation of the polyester resin (3).

### Preparation Example 4

### Synthesis of Polyester Resin (4)

38 g of 1,5-naphthalene dicarboxylic acid methyl ester, 96 g of dimethyl terephthalate, 58 g of dimethyl isophthalate, 136 g of ethylene glycol and 0.1 g of tetrabutoxy titanate as a catalyst were loaded into an autoclave including a thermometer and a stirrer, and then heated at a temperature of 150 to 220° C. for 180 minutes to perform an ester exchange reaction. Then, the temperature was increased to 240° C. and the pressure of the reaction system was slowly reduced for 30 minutes down to 10 mmHg and in this state, the reaction was continuously performed for 70 minutes. Substitution with nitrogen gas was performed thereon and the pressure was controlled to be an atmospheric pressure. The temperature was decreased to 200° C., 2.0 g of trimellitic acid was added thereto, and the reaction was performed for 70 minutes, thereby completing the preparation of the polyester resin (4).

### Preparation Example 5

### Synthesis of Polyester Resin (5)

A 3 L reactor including a stirrer, a thermometer, a condenser, and a nitrogen inlet was placed in an oil bath. 97 g of dimethyl terephthalate, 96 g of dimethyl isophthalate, 0.15 g of dimethyl 5-sulfoisophthalate sodium salt, 175 g of 1,2-propylene glycol, and 4.0 g of trimellitic acid were separately loaded into the reactor. Subsequently, as a polymerization catalyst, tetrabutyl titanate was added thereto in an amount of 500 ppm based on the total amount of a monomer. Then, while a stirring speed of the reactor was maintained at 100 rpm, the temperature was increased to 150° C. Thereafter, the reaction was performed for about 5 hours. When methanol as a by-product of the ester reaction was not produced in a condenser any more, the reaction temperature was increased to 220° C. and the pressure of the reactor was reduced to 0.1 torr and the reaction was further performed for 15 hours, thereby completing the preparation of the polyester resin (5).

### Glass Transition Temperature (Tg, ° C.) Measurement

The glass transition temperature of a sample was measured by using a differential scanning calorimetry (product of Netzsch Company) as follows: a sample was heated at a heating rate of 10° C./minute in a temperature range from 20° C. to 200° C., and then quickly cooled to 10° C. at a cooling rate of 20° C./minute, and then heated again at a heating rate of 10° C./minute.

### Acid Value Measurement

An acid value (mgKOH/g) was measured as follows: a resin was dissolved in dichloromethane and cooled, followed by titration with 0.1 N KOH methyl alcohol solution.

### Weight Average Molecular Weight Measurement

A weight average molecular weight of a binder resin was measured by gel permeation chromatography (GPC) with reference to a calibration curve obtained from a polystyrene reference sample.

TABLE 1

| | Glass transition | Acid | Weight average |
|---|---|---|---|
| | temperature Tg) | value(mgKOH/g) | molecular weight |
| Preparation | 66 | 11 | 18,000 |
| Example 1 | | | |
| Preparation | 62 | 15 | 25,000 |
| Example 2 | | | |
| Preparation | 67 | 17 | 52,000 |
| Example 3 | | | |
| Preparation | 65 | 14 | 16,000 |
| Example 4 | | | |
| Preparation | 80 | 8 | 100,000 |
| Example 5 | | | |

### Preparation Example 6

### Preparation of Polyester Resin Dispersion (1)

30 ml of 1 N sodium hydroxide solution as a dispersion stabilizer, which is an equivalent amount to an acid value of the polyester resin (1), was loaded into a 1 L reactor equipped with a thermometer and an impeller-type stirrer. Then, a surfactant (dowfax, Dow Corning Company, 1 wt % with respect to an amount of polyester resin), and 500 ml of water were added thereto. Then, 150 g of methyl ethyl ketone was added thereto and the temperature was increased to 70° C. to complete the preparation of a solvent emulsion. Thereafter, 100 g of the polyester resin (1) was added thereto in a solid state and dispersed. An organic solvent was removed therefrom by reducing the pressure to 0.3 torr at a temperature of 80° C. Finally, a polyester resin dispersion (1) having a solid content concentration of 17% was obtained. In this case, an average particle size of dispersion particles of the polyester resin dispersion was 0.2 μm. The average particle size was measured by using a microtrack particle size analyzer (NIKKISO, Japan).

### Preparation Example 7

### Preparation of Polyester Resin Dispersion (2)

A polyester resin dispersion (2) was prepared in the same manner as in Preparation Example 6, except that 40 ml of 1 N sodium hydroxide solution was used as a dispersion stabilizer and a polyester resin (2) was used instead of the polyester resin (1). In this case, an average particle size of dispersion particles of the polyester resin dispersion was 0.3 μm.

### Preparation Example 8

### Preparation of Polyester Resin Dispersion (3)

A polyester resin dispersion (3) was prepared in the same manner as in Preparation Example 6, except that 50 ml of 1 N sodium hydroxide solution was used as a dispersion stabilizer and a polyester resin (3) was used instead of the polyester resin (1). In this case, an average particle size of dispersion particles of the polyester resin dispersion was 0.3 μm. The average particle size was measured by using a microtrac particle size analyzer (NIKKISO, Japan).

### Preparation Example 9

### Preparation of Polyester Resin Dispersion (4)

A polyester resin dispersion (4) was prepared in the same manner as in Preparation Example 6, except that 40 ml of 1 N sodium hydroxide solution was used as a dispersion stabilizer and a polyester resin (4) was used instead of the polyester resin (1). In this case, an average particle size of dispersion particles of the polyester resin dispersion was 0.5 μm.

### Preparation Example 10

### Preparation of Polyester Resin Dispersion (5)

A polyester resin dispersion (5) was prepared in the same manner as in Preparation Example 6, except that 10 ml of 1 N sodium hydroxide solution was used as a dispersion stabilizer and a polyester resin (5) was used instead of the polyester resin (1). In this case, an average particle size of dispersion particles of the polyester resin dispersion was 0.4 μm.

### Preparation Example 11

### Preparation of Pigment Dispersion (1)

3 kg of black pigment (Regal 330 R, product of Cabot Company) was loaded into a 20 L reactor, and 11.5 kg of purified water and 0.6 kg of hydroxypropylmethyl cellulose acetate phthalate (AnyCoat-P, product of Samsung Fine Chemical Co., Ltd.) were additionally added to the reactor to perform stirring at a rate of 50 rpm. Subsequently, contents of the reactor were transferred to a ball-mill type reactor to perform a preliminary dispersion. As a result of the preliminary dispersion, dispersed cyan pigment particles having a volume average particle size (D50(v)) of 3.4 μm (measured by using a Beckman Coulter multisizer of Beckman Coulter Company) were obtained. Then, high dispersion was performed on contents of the ball-mill type reactor at a pressure of 1,500 bar by using an Ultimaizer system (Amstec Ltd., Model HJP25030). As a result of the high dispersion, nano-size dispersed cyan pigment particles having D50(v) of 150 nm (measured by using a Microtrac 252 of Microtrac Inc) were obtained.

### Preparation Example 12

### Preparation of Wax Dispersion (1)

50 g of paraffin wax (NIPPON SEIRO, HNP10, melting point 72° C.), 10 g of an anionic surfactant (Dowfax, Dow Corning Company), and 160 g of ion-exchanged water were added to a jacket portion of a homogenizer(IKA Company) and then dispersed for 30 minutes while heating the homogenizer at a temperature of 95° C. for 30 minutes. Then, the dispersed product was transferred to a pressure ejection-type homogenizer (Japan Fine Machine) and then dispersed at a temperature of 90° C. for about 20 minutes, thereby obtaining nano-size dispersed wax dispersion with D50(v) of 230 nm (measured by using a Microtrac 252 of Microtrac Inc).

### Example 1

The polyester resin dispersion (1), the pigment dispersion (1), and the wax dispersion (1) were mixed at solid content concentrations shown in Table 2 below to prepare mixed dispersions. In this regard, a total solid content concentration was controlled to be 13 wt % by using pure water. 53 g of 10% sodium chloride aqueous solution and 10 g of 0.3 M nitric acid aqueous solution were added to the mixed solutions, followed by stirring by using a blend-type stirrer at a rate of 10000 rpm and increasing the temperature to 55° C. The stirring was performed for 3 hours to perform aggregation and then, a pH was controlled to be 10 and the temperature was increased to 96° C. to fuse toner particles. The temperature was decreased to 60° C. and at this temperature, 1 N sodium hydroxide solution was added thereto to adjust a pH to be 9. Coarse powder was filtered through a mesh (pore size of 20 μm), and the aggregate was washed three times with water, and then 0.3 M nitric acid aqueous solution was added thereto to control a pH to be 1.5, followed by three times of washing with pure water and filtering. The filtrate was dried with a fluidized bed dryer to complete the preparation of black toner.

### Examples 2 To 5

The polyester resin dispersions, the pigment dispersions, and the wax dispersions were mixed at the solid content concentrations shown in Table 2 below to prepare mixed dispersions, and then, toner was prepared in the same manner as in Example 1 to prepare black toner.

### Comparative Example 1

The polyester resin dispersion (1), the pigment dispersion (1), and the wax dispersion (1) were mixed at solid content concentrations shown in Table 2 below to prepare a mixed dispersion. In this regard, a total solid content concentration was controlled to be 13 wt % by using pure water. 4.2 g of 10% polyaluminum chloride (PAC) solution and 10 g of 0.3 M nitric acid aqueous solution were added to the mixed dispersions, followed by stirring by using a blend-type stirrer at a rate of 10000 rpm and increasing the temperature to 55° C. The stirring was performed for 3 hours to perform aggregation, and then, 1 N NaOH was added thereto to adjust a pH to be 10 and 12 g of EDTA was added thereto to deactivate multivalent metal salt and the temperature was increased to 96° C. to fuse toner particles. The temperature was decreased to 60° C. and at this temperature, 1 N sodium hydroxide solution was added thereto to adjust a pH to be 9. Coarse powder was filtered through a mesh (pore size of 20 μm), and the aggregate was washed three times with water, and then 0.3 M nitric acid aqueous solution was added thereto to control a pH to be 1.5, followed by three times of washing with pure water and filtering. The filtrate was dried with a fluidized bed dryer to complete the preparation of black toner.

In Table 2 below, the amounts of the polyester resin dispersion, the wax dispersion, and the pigment dispersion are represented in wt % based on a solid content amount. An amount of the coagulant is represented in wt % based on a total solid amount in aggregation reaction dispersions.

TABLE 2

| | | | | | | | Comparative |
|---|---|---|---|---|---|---|---|
| | | Example 1 | Example 2 | Example 3 | Example 4 | Example 5 | Example 1 |
| Polyester resin | Polyester | 86 | 86 | 86 | 86 | 86 | 86 |
| dispersion | Polyester resin | | | | | | |
| | Acid value | 11 | 15 | 17 | 14 | 8 | 11 |
| | NaOH amount | 30 ml | 40 ml | 50 ml | 40 ml | 10 ml | 30 ml |
| Pigment | Pigment | 7 | 7 | 7 | 7 | 7 | 7 |
| dispersion | | | | | | | |
| Wax dispersion | Wax | 7 | 7 | 7 | 7 | 7 | 7 |
| coagulant | NaCl | 0.55 | 0.25 | 12 | 0.55 | 0.55 | |
| | PAC | | | | | | 0.42 |
| pH | | 5.7 | 5.7 | 5.7 | 4.5 | 6.5 | 3.0 |

The average particle size, circularity, image quality, gloss, and preservation of the toner particles prepared according to Examples 1 to 5 and Comparative Example 1 were evaluated as below, and results thereof are shown in Table 3 below.

### Average Particle Size

An average particle size of toner particles was measured by using Coulter Multisizer III (Backman Coulter Inc., USA), and 50000 particles were counted and an aperture used was 100 μm.

### Circularity

Circularity was evaluated by using FPIA-3000 (product of Sysmex Company, located in Japan). In evaluating circularity by using FPIA-3000, samples were prepared by adding an appropriate amount of a surfactant to 50 to 100 ml of distilled water and adding 10 to 20 mg of toner particles thereto, followed by dispersing for 1 minute in an ultrasound dispersion device.

Circularity was automatically calculated according to the following equation in FPIA-3000.

$$Circularity = \frac{2 \sqrt{area \times π}}{perimeter}$$

In the equation above, the area indicates an area of projected toner, and the perimeter indicates a circumference of a circle having the same area as that of projected toner. The circularity value may be in a range of 0 to 1, and as the value approaches 1, it indicates that the shape is more like a circle.

### Image Evaluation

The image evaluation was performed by using a remodeled CP 2025(HP) device, which is a digital full color printer. An image density was measured by using a SpectroEye (GretagMacbeth Company), which is a spectrophotometer.

ok: 1.3 or more of image density

ng: lower than 13 of image density

### Gloss Evaluation

The gloss evaluation was performed by using a remodeled CP 2025(HP) device, which is a digital full color printer. A gloss measurement device (GretagMacbeth Company) was used herein.

ok: 13 or more of gloss

ng: less than 13 of gloss

### Preservation

The preservation evaluation was performed by preserving 5 g of toner contained in a 50 ml sample bottle in a chamber at a temperature of 50° C. in a humidity of 80% for 24 hours. The preserved sample was taken out of the chamber and left to sit at room temperature and a degree of aggregation was confirmed with the naked eyes, followed by sifting with a 100 μm sieve. Then, the remaining amount was measured, and if the amount was more than 10%, the evaluation results were indicated as ‘ng’, and if the amount was 10% or less, the evaluation results were indicated as ‘ok’.

### Fixing Temperature

A 30 mm×40 mm solid-phase non-fixed image was collected in a Samsung CLP-510 printer by using toner prepared by mixing 9.75 g of toner particles prepared in Examples 1 to 3 and Comparative Examples 1 to 3, 0.2 g of silica (TG 810G; product of Cabot Company), and 0.05 g of silica (RX50; product of Degussa Company). Subsequently, in a fixing tester that had been remodeled to allow a fixing temperature to be changed arbitrarily, the fixing property of the non-fixed image was evaluated while the temperature of a fixing roller was changed. A temperature region in which cold off-set or hot off-set did not occur was recorded and the evaluation results are shown in Table 3 below.

### Metal Amount Remaining In Toner

ICP analysis was performed on prepared toner to measure an amount of an inorganic metal in toner.

TABLE 3

| | | | | | | | | | | |
|---|---|---|---|---|---|---|---|---|---|---|
| Example 1 | 6.5 | 0.988 | 1.4 | ok | 16 | ok | 6% | ok | 135 to 180° C. | 0.5% |
| Example 2 | 5.8 | 0.975 | 1.3 | ok | 14 | ok | 7% | ok | 140 to 170° C. | 0.7% |
| Example 3 | 11 | 0.977 | 1.3 | ok | 13 | ok | 8% | ok | 150 to 170° C. | 0.65% |
| Example 4 | 6.4 | 0.963 | 1.3 | ok | 13 | ok | 9% | ok | 150 to 190° C. | 0.5% |
| Example 5 | 13 | 0.973 | 1.3 | ok | 13 | ok | 15% | ng | 150 to 190° C. | 0.8% |
| Comparative | 7.0 | 0.958 | 0.9 | ng | 5 | ng | 15% | ng | 160 to 200° C. | 10% |
| Example 1 | | | | | | | | | | |

As shown above, toner particles prepared according to the above embodiments of the present invention have a narrow particle size distribution, excellent gloss and preservation characteristics, and a high image quality. Also, prepared toner has a substantially decreased residual metal.

It should be understood that the exemplary embodiments described herein should be considered in a descriptive sense only and not for purposes of limitation. Descriptions of features or aspects within each embodiment should typically be considered as available for other similar features or aspects in other embodiments.

1. A method of preparing toner, the method comprising:
mixing a polyester resin dispersion, a colorant dispersion, and a wax dispersion to prepare a mixed dispersion;
aggregating toner particles by adding an agglomerating agent to the mixed dispersion; and
fusing the aggregated toner particles,
wherein an inorganic base of a monovalent metal is used as a dispersion stabilizer added to the polyester resin dispersion, and an inorganic salt of a monovalent metal is used as a coagulant for the agglomerating.

2. The method of claim 1, wherein the dispersion stabilizer is NaOH, LiOH, or KOH.

3. The method of claim 1, wherein the coagulant is NaCl or KCl.

4. The method of claim 1, wherein an amount of the coagulant is in a range of 0.3 to 5 wt % based on a total solid content weight in a reaction dispersion during the aggregation.

5. The method of claim 1, further comprising, following the fusing, washing and drying toner particles.

6. The method of claim 1, wherein the polyester resin dispersion is prepared by:
preparing a solvent emulsion by stirring a mixture comprising a dispersion stabilizer, a surfactant, a polar solvent, and an organic solvent that is not miscible with the polar solvent; and
adding a polyester resin to the solvent emulsion.

7. The method of claim 1, wherein a weight average molecular weight of the polyester resin is in a range of 6,000 to 100,000, and a glass transition temperature of the polyester resin is in a range of 40 to 80° C.

8. The method of claim 6, wherein the polar solvent is water.

9. The method of claim 6, wherein the organic solvent comprises at least one selected from the group consisting of methyl acetate, ethyl acetate, isopropyl acetate, methyl ethyl ketone, dimethyl ether, diethyl ether, 1,1-dichloroethane, 1,2-dichloroethane, dichloromethane, and chloroform.
